(19) United States
(12) Patent Application Publication
(10) Pub. No.: US 2007/0248857 A1
(43) Pub. Date: Oct. 25, 2007

(54) FUEL CELL SYSTEM

(75) Inventor: Atsushi Kurosawa, Shizuoka-ken 438-8501 (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/738,902

(22) Filed: Apr. 23, 2007

(30) Foreign Application Priority Data
Apr. 21, 2006 (JP) 2006-117342

(51) Int. Cl. H01M 8/04

(52) U.S. Cl. 429/22; 429/24; 429/13

(57) ABSTRACT

A fuel cell system includes a fuel cell and a power source system control device. The control device is configured to determine a humidification state in the fuel cell based on a difference between power consumption of an air blower that supplies air to the fuel cell and a preset threshold value. The pressure of air to be supplied to the fuel cell is set to a pressure that is greater than the pressure of air to be discharged from the fuel cell. When the fuel cell has an excessive humidity, the temperature of the fuel cell can be increased to improve the operating efficiency of the fuel cell.

### CROSS-REFERENCE TO RELATED APPLICATIONS

The present application is based on and claims priority under 35 U.S.C. § 119 to Japanese Patent Application No. 2006-117342, filed on Apr. 21, 2006, the entire contents of which are expressly incorporated by reference herein

### BACKGROUND OF THE INVENTION

1. Field of the Invention

The present invention relates to a fuel cell system, and more particularly to a fuel cell system having a controller that determines a humidification state in a fuel cell and that adjusts the same.

2. Description of the Related Art

Some conventional devices, such as vehicles, operate on electric power generated by a fuel cell system having a fuel cell. The operating condition of such a fuel cell system depends to a large degree on the amount of water (humidification amount) contained in the electrolyte membrane in the fuel cell. Japanese Publication No. JP 2000-243418 discloses a fuel cell system having a humidification control means for determining whether the amount of water in the electrolyte membrane is excessive or insufficient, and for controlling the humidification state in the fuel cell based on this determination to maintain the fuel cell system in good operating condition.

The fuel cell system has a current detection means for detecting the current output from the fuel cell, a resistance detection means for detecting the resistance of the fuel cell during a current sweep, and a humidification state determination means for determining the humidification state of an electrolyte membrane based on the current detected by the current detection means and the resistance detected by the resistance detection means. The fuel cell system also has a humidification control means for controlling the amount of humidity in the fuel cell. The humidification control means decreases the humidity in the fuel cell when the humidification state determination means determines that the humidification state of the electrolyte membrane is excessive.

In the conventional fuel cell system described above, however, since the resistance detection means must be provided in the cells or the cell stack of the fuel cell, the number of components used in the fuel cell system is large and the entire structure of the fuel cell system is complicated. In addition, because the output current needs to be swept when the internal resistance of the fuel cell is detected, the control method is complicated. In other words, in the fuel cell system disclosed in JP 2000-243418, because the internal resistance of the fuel cell is obtained based on a change in output current, the humidification state cannot be determined when there is no change in the output current. The voltage detection means can be used as the resistance detection means but, in this case, an operating condition must be changed to increase the amount of air to be supplied to the fuel cell when determining the humidification state.

### SUMMARY OF THE INVENTION

In view of the circumstances noted above, an aspect of at least one of the embodiments disclosed herein is to provide a fuel cell system which is simple in structure and easy to control, and which has a humidification state determination controller that can determine the humidification state in a fuel cell without changing an operating condition of the fuel cell and that can adjust the humidification state of the fuel cell.

Thus, one aspect of an embodiment of the present invention involves a fuel cell system comprising a fuel cell configured to generate electric power through a reaction between hydrogen gas and oxygen gas in air supplied from an air supply device operated at least in part by an electric motor. The system also comprises a humidification state determination controller configured to determine the humidification state of the fuel cell based at least in part on the difference between an amount of electric power consumed by the electric motor when air is supplied from the air supply device to the fuel cell and a threshold value of power consumption.

Another aspect of an embodiment of the present invention involves a fuel cell system comprising a fuel cell configured to generate electric power through a reaction between hydrogen gas and oxygen gas. The system further comprises an air supply device in communication with the fuel cell. The air supply device supplies air to the fuel cell. The air supply device is operated at least in part by an electric motor. The system also comprises a controller configured to determine a humidification state of the fuel cell based at least in part on a difference between an amount of electric power consumed by the electric motor to supply air from the air supply device to the fuel cell and a threshold value of power consumption. The controller further is configured to adjust the operating temperature of the fuel cell to adjust the humidification state of the fuel cell.

A further aspect of an embodiment of the present invention involves a method for operating a fuel cell system. The method comprises flowing an amount of air and hydrogen to a fuel cell to generate electricity via a reaction of hydrogen and oxygen in the air; calculating an amount of power consumed by an air supply device that supplies air to the fuel cell; comparing the calculated power amount to a threshold power consumption value; determining based on said comparison if the humidity level in the fuel cell is adequate or excessive; and adjusting an operating characteristic of the fuel cell system based upon the determination.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following four figures.

FIG. 1 is a schematic side view illustrating a motorcycle provided with a fuel cell system according to one embodiment.

FIG. 2 is a configuration diagram of the fuel cell system, in accordance with one embodiment.

FIG. 3 is a flowchart illustrating a program for controlling a humidification state in the fuel cell.

FIG. 4 is a map showing a relationship between an amount of air supplied to the fuel cell and power consumption consumed by an air blower.

### DETAILED DESCRIPTION OF THE PREFERRED EMBODIMENT

In the following detailed description, terms of orientation such as “right,” “left,” “front,” “rear,” “frontward,” and “rearward” are used to simplify the description. Moreover, left, right, front and rear directions are described hereinbelow as directions as seen from a driver seated on a seat of a vehicle, such as a motorcycle. Likewise, terms of sequence, such as “first” and “second,” are used to simplify the description of the illustrated embodiments. Because other orientations and sequences are possible, however, the present invention should not be limited to the illustrated orientation unless specifically required in the claims. Those skilled in the art will appreciate that other orientations of the various components described above are possible.

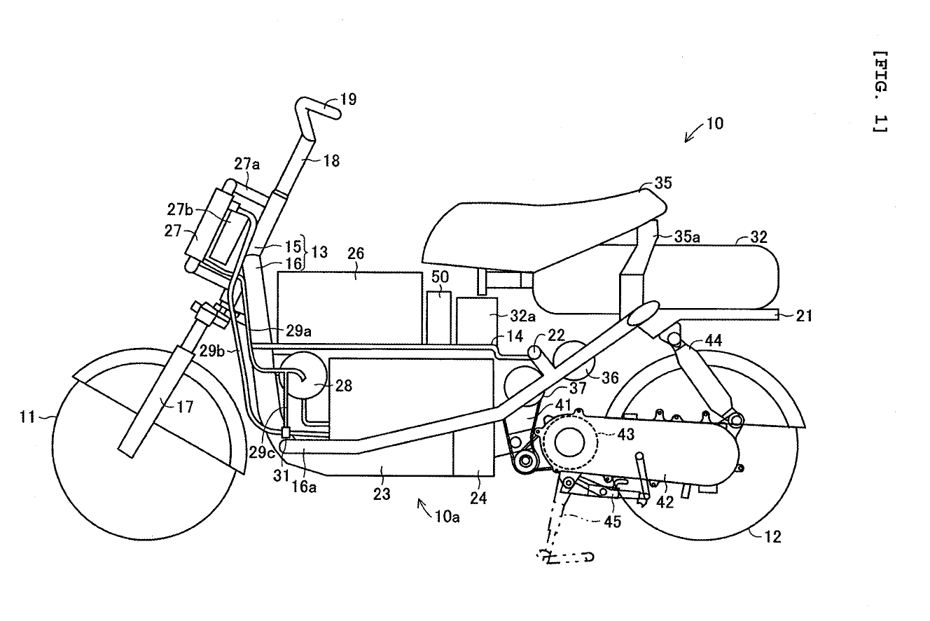

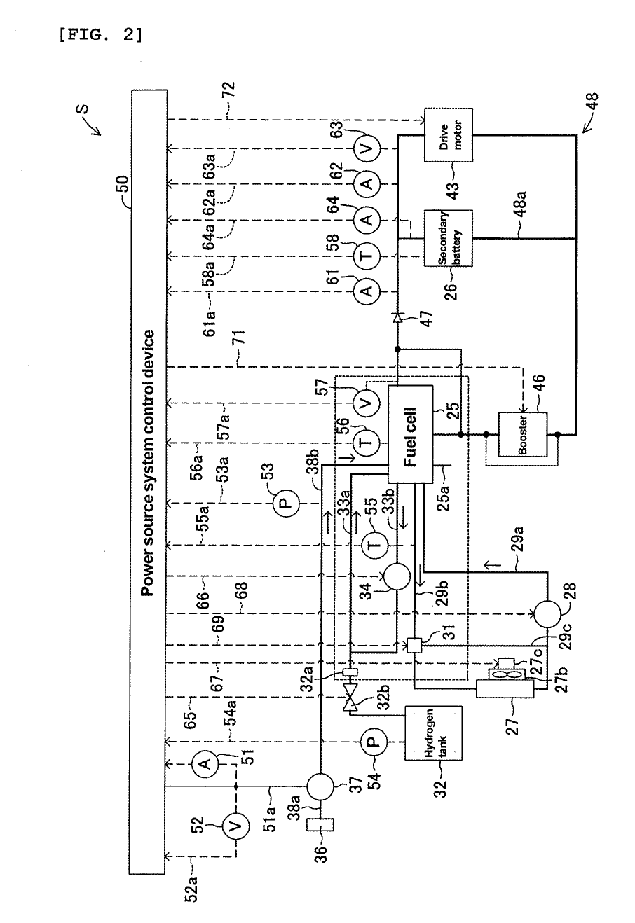

FIG. 1 shows a motorcycle 10 provided with a fuel cell system S (see FIG. 2) according to one embodiment that is arranged and configured in accordance with certain features, aspects and advantages of the present invention. The motorcycle 10 has a pair of wheels, including a front wheel 11 and a rear wheel 12, and a vehicle body 10a, to which the wheels 11, 12 are attached. The vehicle body 10a has a body frame 13 and a sub-frame 14 removably attached to the body frame 13. The body frame 13 has a head pipe 15 forming a front part of the vehicle body 10a and a down tube 16 extending backward from the head pipe 15. Additionally, the inventions disclosed herein are not limited to a so-called motorcycle-type two-wheel vehicle, but are applicable to other types of two-wheel vehicles. Moreover, the inventions disclosed herein are not limited to two-wheel vehicles, but may be used with other types of straddle-type vehicle. Furthermore, some aspects of the invention disclosed herein are not limited to straddle-type vehicles, but can also be used with vehicles with side-by-side seating or other forms of seating configurations.

In the illustrated embodiment, the front wheel 11 is rotatably supported at the lower end of a front fork 17. In other words, both lower ends of the front fork 17 rotatably support both ends of the axle (not shown) of the front wheel 11 to allow rotation of the front wheel 11 about the axle. The lower end of a steering shaft 18, which extends into the head pipe 15, is connected to the upper end of the front fork 17. The steering shaft 18 is mounted to the head pipe 15 so that it can rotate about the axis of the head pipe 15, and has an upper end protruding from the head pipe 15 and extending upward.

The upper end of the steering shaft 18 is connected to the center of a handle bar 19 disposed generally horizontally and extending laterally. Therefore, when the handle bar 19 is turned to rotate the steering shaft 18 about its axis, the front wheel 11 can turn to the right or left about the axis of the front fork 17 in proportion to the amount of rotation of the steering shaft 18. Grips (not shown) are provided at both ends of the handle bar 19.

One of the grips is provided for rotation about its axis, and constitutes an accelerator operation element for controlling the drive power of a drive motor 43, described below, in addition to being used as a grip portion to be held by a hand of a user. The other grip is mounted to the handle bar 19 and used as a grip portion that is held by a hand. Brake levers (not shown), which are urged away from the grips and which are connected to a braking system to slow the rotation of the front wheel 11 or the rear wheel 12 when pulled toward the grips, preferably are disposed in the vicinity of the grips.

In the illustrated embodiment, the down tube 16 has a pair of curved main frames 16a (only one of which is shown), the front ends (upper ends) of which are connected to both sides of a lower part of the head pipe 15. The main frames 16a extend backward and obliquely downward from the joints with the head pipe 15 with the distance between them increasing, and then curve and extend horizontally backward. In addition, the main frames 16a have rear end portions extending backward and obliquely upward with the distance between them kept substantially constant. The rear ends of the main frames 16a are connected to a plate-shaped mounting member 21 disposed horizontally.

A cross member 22 extends across upper sides of rear parts of the main frames 16a. The cross member 22 can be formed of a generally U-shaped rod with both ends bent generally at a right angle, and a main portion can protrude upward from the main frames 16a with the bent ends connected to the main frames 16a. A mount table 23 protruding downward between the main frames 16a extends across the lower ends of the main frames 16a. The upper side of the mount table 23 can be recessed to form therein a fuel cell accommodating section 24. A fuel cell (see FIG. 2) is accommodated in the fuel cell accommodating section 24.

A sub-frame 14, which can be plate-like, is attached between a front part of the main frames 16a, such as the down tube 16, and the cross member 22, which is positioned on a rearward portion of the main frames 16a. A power storage device can be mounted to the sub-frame 14. As used herein, “power storage device” means a power storage device (e.g., a battery or a capacitor assembly) coupled to an operating device (e.g., an electric motor) to supplement power from a primary power supply (e.g., a fuel cell). In the illustrated embodiment, the power storage device 26 is a battery 26, which can be a lithium ion battery. The battery 26 can be mounted to a portion of the upper surface of the sub-frame 14 slightly forward of the center thereof, and a power source system control device 50 that controls the devices of the fuel cell system S can be mounted on a rear part of the upper surface the sub-frame 14. In one embodiment, the battery 26 can operate as a supplementary power source that selectively provides power to the drive motor 43, in addition to or in place of power provided from the fuel cell system S to the drive motor 43, to propel at least one of the wheels 11, 12.

A radiator 27 is attached to a front part of the head pipe 15 via a mounting member 27a, and a fan 27b for air-cooling the radiator 27 is attached behind the radiator 27 (between the radiator 27 and the head pipe 15). The fan 27b is driven by a motor 27c. A water pump 28 is attached to a front portion of the down tube 16 in front of the fuel cell accommodating section 24 and below the sub-frame 14 (e.g., below the battery 26).

The radiator 27 and the fuel cell 25 are connected by a cooling water pipe 29a through which cooling water flows from the radiator 27 to the fuel cell 25. The water pump 28 preferably is provided along the cooling water pipe 29a. That is, the cooling water pipe 29a extends from the radiator 27 to the water pump 28 and then from the water pump 28 to the fuel cell accommodating section 24, extends into the fuel cell accommodating section 24 through a front side thereof, and connects to the fuel cell 25.

Also, the fuel cell 25 and the radiator 27 are connected by a cooling water pipe 29b through which cooling water, having cooled the fuel cell 25, flows from the fuel cell 25 to the radiator 27. The cooling water pipe 29b extends from the fuel cell 25 through the front side of the fuel cell accommodating section 24 to the radiator 27. Therefore, when the water pump 28 is activated, the cooling water in the radiator 27 is fed to the fuel cell 25 through the cooling water pipe 29a to cool the fuel cell 25. Then, the cooling water, which has cooled the fuel cell 25 and absorbed heat therefrom, is returned to the radiator 27 through the cooling water pipe 29b and cooled by the fan 27b while passing through the radiator 27.

A bypass passage 29c extends between a portion of the cooling water pipe 29a upstream of the water pump 28 and a portion of the cooling water pipe 29b. A three-way valve 31 is provided at the point where the bypass passage 29c and the cooling water pipe 29b meet. The three-way valve 31 can be operated to open or close the path between the upstream part and the downstream part of the cooling water pipe 29b. The upstream part of the cooling water pipe 29b communicates with the bypass passage 29c when the path between the upstream part and the downstream part of the cooling water pipe 29b is closed. Therefore, when the path between the upstream part and the downstream part of the cooling water pipe 29b is closed by the three-way valve 31, the upstream part of the cooling water pipe 29b, the bypass passage 29c and the downstream part of a cooling water pipe 29a form a short flow passage via the fuel cell 25.

In this case, the capacity for cooling the fuel cell 25 decreases, and the temperature of the fuel cell 25 increases. In other words, the temperature of the fuel cell 25 can be increased by operating the three-way valve 31 to place the upstream part of the cooling water pipe 29b in communication with the bypass passage 29c, and the capacity for cooling the fuel cell 25 can be increased (e.g., the temperature can be decreased) when the upstream part and the downstream part of the cooling water pipe 29b are placed in communication with each other. Also, the cooling capacity can be further increased when the drive power of the motor 27c is increased with the upstream part and the downstream part of the cooling water pipe 29b in communication with each other.

With continued reference to the embodiment illustrated in FIG. 1, a hydrogen tank 32 filled with hydrogen to be supplied to the fuel cell 25 is attached to the upper side of the mounting member 21 connected to the rear ends of the main frames 16a. The hydrogen tank 32 can be connected to the fuel cell 25 via a connector 32a. That is, as shown in FIG. 2, the hydrogen tank 32 is connected to a hydrogen gas supply port of the fuel cell 25 by a gas pipe 33a for feeding hydrogen, and the connector 32a is provided on the gas pipe 33a.

The fuel cell 25 also has a hydrogen gas discharge port connected to a part of the gas pipe 33a in the vicinity and downstream of the connector 32a by a gas pipe 33b for circulation. A valve 32b for opening and closing the gas pipe 33a is provided in a hydrogen tank 32 side part of the gas pipe 33a. A circulation pump 34 for returning hydrogen gas discharged from the hydrogen gas discharge port of the fuel cell 25 to the gas pipe 33a is provided in the gas pipe 33b. Therefore, when the valve 32b is opened, the hydrogen gas in the hydrogen tank 32 can be supplied to the fuel cell 25 through the gas pipe 33a.

When the circulation pump 34 is activated, unreacted hydrogen gas remaining in the fuel cell 25 can be returned to the gas pipe 33a through the gas pipe 33b and joined to hydrogen gas newly fed from the hydrogen tank 32 into the gas pipe 33a. Then, the hydrogen gas is circulated in the gas pipes 33a and 33b before being reacted with oxygen gas in the fuel cell 25. A seat 35 is disposed above a front part of the hydrogen tank 32. The seat 35 is connected to rear parts of the main frame 16a via support members 35a.

An air filter 36 is attached to a rear parts of the main frames 16a behind the cross member 22, and an air blower 37 having a motor (e.g., an electric motor) is attached to rear parts of the main frames 16a in front of the cross member 22. A mount table (not shown) is provided between rear parts of the main frames 16a, and the air filter 36 and the air blower 37 are mounted to the down tube 16 via the mount table.

The air filter 36 and the air blower 37, and the air blower 37 and fuel cell 25 are connected by gas pipes 38a and 38b, respectively, shown in FIG. 2, and outside air is sucked through the air filter 36 and supplied to the fuel cell 25 when the air blower 37 is activated. Foreign objects in the air sucked into the air filter 36 are removed while the air passes through the air filter 36. The air filter 36 and the air blower 37 constitute an air supply device. The fuel cell 25 also has an air discharge port 25a through which air remaining after the reaction between oxygen gas and hydrogen gas in the fuel cell 25 is discharged to the outside. The pressure of air to be supplied from the air blower 37 to the fuel cell 25 through the gas pipe 38b is set to a value that is slightly greater than the pressure of air to be discharged from the air discharge port 25a.

A rear arm (not shown) having a pair of arm members extending backward is connected to lower rear parts of the main frames 16a via a connection member 41. The ends of the axle of the rear wheel 12 are rotatably supported at the rear ends of the arm members of the rear arm to allow rotation of the rear wheel 12 about the axle. A motor unit 42 is attached to the outside of one of the arm members of the rear arm in such a manner as to cover the arm member. A drive motor 43, which can be operated on electric power generated by at least the fuel cell 25, and a reduction mechanism are housed in the motor unit 42. The rear wheel 12 is rotated by the operation of the drive motor 43 to propel the motorcycle 10.

Shock absorbers 44 extend between the rear ends of the main frames 16a and the upper rear ends of the rear arm. The expansion and contraction of the shock absorbers 44 allows swinging movement of the rear end of the rear arm. A brake, such as a drum brake (not shown) is attached on the side of the inner side the motor unit 42. The operation of the drive motor 43 is controlled by the power source system control device 50 in accordance with the amount by which the grip is operated, and automatically generates drive power in the rear wheel 12.

The motorcycle 10 has a rotary stand 45 for keeping the motorcycle 10 in an upright state when it is in a stationary state. The stand 45 is moved to its upper position as shown by solid lines in FIG. 1 when the motorcycle 10 is driven, and moved to its lower position as shown by double-dot dash lines in FIG. 1 so that the stand 45 can support the motorcycle 10 when the motorcycle 10 is held stationary. In addition, the fuel cell system S has a booster 46 for raising the voltage of the electric power generated by the fuel cell 25 and a backflow-preventing diode 47. An electric circuit 48 can comprise the fuel cell 25, the battery 26, the drive motor 43, the booster 46, the diode 47, and electric wires connecting them.

In addition, each of the components comprising the fuel cell system S can have a sensor for detecting various conditions thereof, and the sensors and the power source system control device 50 can be connected via electric wires. In another embodiment, the sensors can communicate with the power source system control device 50 via a wireless connection (e.g., Rf communication). For example, the air blower 37 can have a current sensor 51 for detecting the current supplied to the air blower 37 and a voltage sensor 52 for detecting the voltage applied to the air blower 37, and the gas pipe 38b can have a pressure sensor 53 for detecting the pressure of air being supplied from the air blower 37 to the fuel cell 25.

The hydrogen tank 32 can have a residual amount detection sensor 54, which can be a pressure sensor, that is used to detect the amount of hydrogen remaining in the hydrogen tank 32, and the cooling water pipe 29b can have a temperature sensor 55 for detecting the temperature of cooling water being fed from the fuel cell 25 to the radiator 27 after having been fed from the radiator 27 to the fuel cell 25 to cooled the fuel cell 25. The fuel cell 25 can have a temperature sensor 56 for detecting the temperature of the fuel cell 25 and a voltage sensor 57 for detecting the voltage value in the fuel cell 25, and the battery 26 can have a temperature sensor 58 for detecting the temperature of the battery 26.

The electric circuit 48 can have a current sensor 61 for detecting the current value supplied from the fuel cell 25, a current sensor 62 for detecting the current flowing to the drive motor 43, and a voltage sensor 63 for detecting the voltage being applied to the drive motor 43. An electric wire 48a connected to the battery 26 in the electric circuit 48 can have a current sensor 64 for detecting the current flowing to the battery 26. As illustrated in the embodiment of FIG. 2, the sensors are connected to the power source system control device 50 via electric wires 51a, 52a, 53a, 54a, 55a, 56a, 57a, 58a, 61a, 62a, 63a and 64a, respectively, and send a detected value as an electric signal to the power source system control device 50. However, as discussed above, in another embodiment, the sensors can be wirelessly connected to the power source system control device 50.

Electric wires 65, 66, 67, 68, 69, 71 and 72 for transmitting a command signal from the power source system control device 50 to the valve 32b, the circulation pump 34, the motor 27c, the water pump 28, the three-way valve 31, the booster 46 and the drive motor 43, respectively, connect the power source system control device 50 and corresponding devices. The air blower 37 supplies air to the fuel cell 25 in response to a flow rate command signal sent from the power source system control device 50 through the electric wire 51a. The valve 32b opens or closes in response to an open/close command signal from the power source system control device 50 to supply hydrogen gas from the hydrogen tank 32 to the fuel cell 25.

The fuel cell 25 generates water and electricity through a reaction between oxygen in the air supplied from the air blower 37 and hydrogen supplied from the hydrogen tank 32. The booster 46 can raise the voltage of the electricity generated by the fuel cell 25 in response to a voltage command signal from the power source system control device 50, and supplies the electricity to the drive motor 43 and to the battery 26 to charge the battery 26. The circulation pump 34 can be activated in response to an operation command signal from the power source system control device 50 and returns unreacted hydrogen gas from the fuel cell 25 to the gas pipe 33a through the gas pipe 33b so that it combines with hydrogen gas from the hydrogen tank 32 flowing through the gas pipe 33a.

The water pump 28 can be activated in response to an operation command signal from the power source system control device 50 and circulates cooling water between the radiator 27 and the fuel cell 25 to maintain the temperature of the fuel cell 25 at a prescribed temperature. The motor 27c can drive the fan 27b in response to an operation command signal from the power source system control device 50 to air-cool the radiator 27. The three-way valve 31 can be activated in response to an operation command signal from the power source system control device 50 and opens or closes the path between the upstream part and the downstream part of the cooling water pipe 29 to communicate the upstream part and the downstream part of the cooling water pipe 29b with each other or closes the path between the upstream part and the downstream part of the cooling water pipe 29 to communicate the upstream part of the cooling water pipe 29b with the bypass passage 29c.

The drive motor 43 can receive an operation signal from the power source system control device 50 corresponding to the amount by which the grip constituting an accelerator grip is operated (e.g., torque or power request). The drive motor 43 is activated in response to the operation signal. The power source system control device 50 can have a CPU, a RAM, a ROM, a timer and so on. Various programs and data such as a map prepared in advance can be stored in the ROM. The CPU can control the motor 27c, the water pump 28, the three-way valve 31, the valve 32b, the circulation pump 34, the air blower 37, the drive motor 43 and the booster 46 based the operation of the grip by the rider or the programs and so on prepared in advance. In addition, the motorcycle 10 can have a power switch and a main switch (which are not shown). In FIG. 2, the cooling water pipe 29a and so on shown by solid lines represent pipes or electric wires through which drive current flows, and the electric wire 52a and so on shown by broken lines represent signal lines.

When the rider drives the motorcycle 10, the rider first sits astride the seat 35. The rider then turns on the power switch and the main switch. Air and hydrogen are supplied to the fuel cell 25 from the air blower 37 and the hydrogen tank 32, respectively, and the fuel cell 25 generates electricity through a reaction between oxygen in the supplied air and the hydrogen. The drive motor 43 is driven by the electricity generated by the fuel cell 25, and the motorcycle 10 starts running. At this time, the fuel cell 25 is cooled by cooling water fed from the radiator 27 by operation of the water pump 28 and is maintained at a prescribed temperature. Also, the fuel cell 25 discharges water generated through the reaction between the oxygen and hydrogen to the atmosphere together with waste gas. The waste gas is discharged into the atmosphere via the air discharge port 25a.

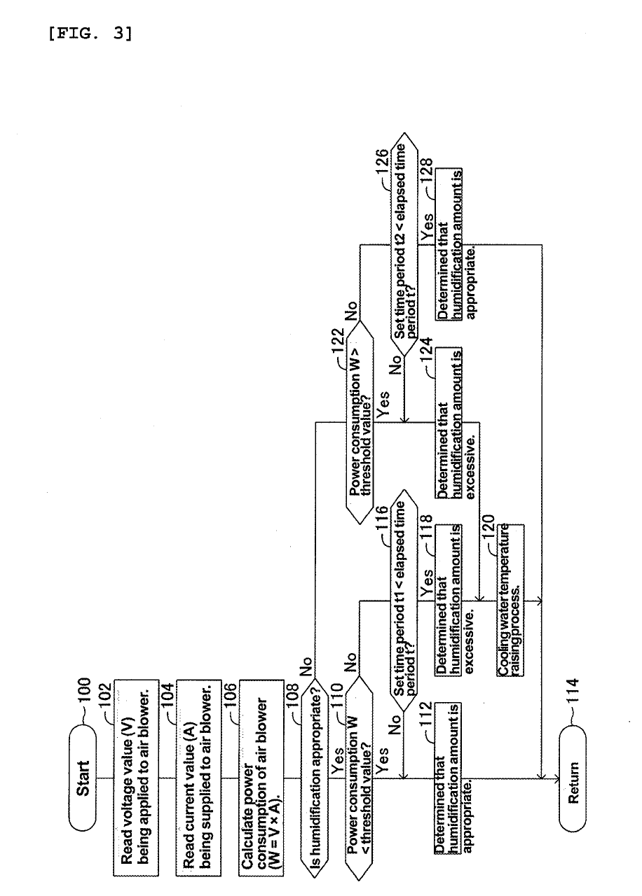

While the motorcycle 10 is running, when moisture accumulates in the fuel cell 25, the inside of the fuel cell 25 may become excessively humidified. When the fuel cell 25 is in an excessively humidified state, the reaction between hydrogen and oxygen decelerates and the power generation efficiency decreases. That is, when the fuel cell is in an excessively humidified state, the inside of fuel cell 25 is in a clogged state and the air supplied from the blower 37 to the fuel cell 25 cannot easily pass through the fuel cell 25. As a result, the operating condition of the motorcycle 10 deteriorates. Therefore, in one embodiment, the power source system control device 50 can perform the program shown in the flowchart of FIG. 3 to allow the fuel cell 25 to generate electricity while resolving the excessive humidification in order to maintain the motorcycle 10 in a good driving condition. The program which is performed to allow the fuel cell 25 to generate electricity while resolving the excessively humidified state can be stored in the ROM, and can be repeatedly performed every prescribed period of time by the CPU after the power switch has been turned on. In other embodiments, the program can be stored in other suitable storage devices, such as flash memory, RAM, etc.

After being started in step 100, the program goes to step 102, in which a process of reading a voltage value V being applied to the motor of the air blower 37 and detected by the voltage sensor 52 is carried out. The applied voltage value V can be temporarily stored in the RAM; however, the applied voltage value V can be stored in other suitable storage devices, such as flash memory, etc. Then, the program goes to step 104, in which a process of reading a current value A being supplied to the air blower 37 and detected by the current sensor 51 is carried out. The current value A can also be temporarily stored in the RAM or other suitable storage device. Then, in step 106, the power consumption W of the air blower 37 is calculated from the data of the applied voltage value V and the current value A stored in the RAM. The power consumption W is obtained as the product of the applied voltage value V and the current value A. This process can be carried out by the CPU.

Then, in step 108, it is determined whether or not the humidification amount in the fuel cell 25 is appropriate. Here, based on a determination on whether or not the humidification amount was appropriate made in any one of steps 112, 118, 124 and 128, which are described later, when the program was executed last time, a determination is made to confirm the determination. In an initial stage after the start of the program, the humidification amount is set to be appropriate. Therefore, “YES” is selected in step 108 upon start of the program, and the program goes to step 110. Then, in step 110, it is determined whether or not the power consumption W is smaller than a threshold value, which in one embodiment can be set in advance.

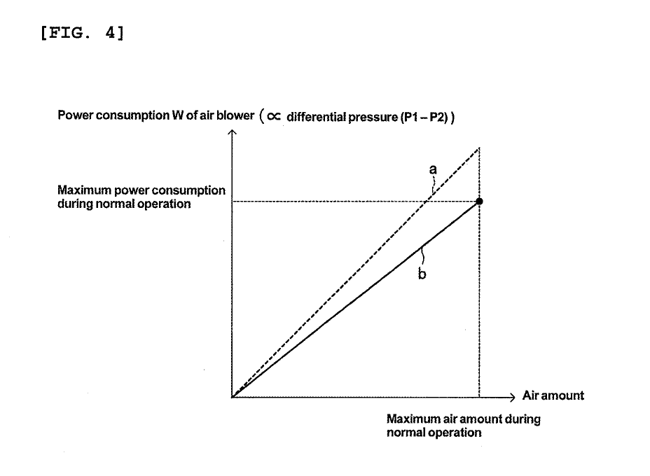

Here, it is determined whether the humidification amount is appropriate or excessive based on the relation between the value of the power consumption W obtained in the process in step 106 and a map of air supplied to the fuel cell versus the power consumption of the air blower, such as the map shown in FIG. 4. The map, which can be prepared and stored in the ROM in advance, shows a relationship between the power consumption W of the motor for driving the air blower 37 and the amount of air supplied from the air blower 37 to the fuel cell 25. A broken line (a) in the map represents the threshold value. The region above the broken line (a) is the region in which the humidification amount is determined to be excessive, and the region below the broken line (a) is the region in which the humidification amount is determined to be appropriate. The solid line (b) in the map shown in FIG. 4 shows the relationship between the power consumption W and the amount of air supplied to the fuel cell 25 in an appropriate state during normal operation.

The power consumption W increases and decreases in proportion to the difference between the pressure P1 of air being supplied from the air blower 37 to the fuel cell 25, which is the pressure in the gas pipe 38b detected by the pressure sensor 53, and the pressure P2 (atmospheric pressure) of waste gas discharged from the air discharge port 25a of the fuel cell 25 into the atmosphere. That is, when the humidification amount in the fuel cell 25 increases, the air supplied from the air blower 37 to the fuel cell 25 cannot pass through the fuel cell 25 easily, and the difference between the pressure P1 of the air being supplied to the fuel cell 25 and the pressure P2 of the waste gas to be discharged from the air discharge port 25a increases. Since the power consumption of electric motor of the air blower 37 varies largely in response to a change in the humidification state even when a change in the differential pressure between the supply air pressure and the discharge air pressure is small, the humidification state can be easily and very reliably determined.

Therefore, the air blower 37 is controlled to increase the drive power of the motor so that a prescribed amount of air can be supplied to the fuel cell 25, and the power consumption W increases as the difference between the pressure P1 and the pressure P2 increases. Thus, in step 108, it can be determined whether the fuel cell 25 is in an excessively humidified state or in an appropriate state by determining whether or not the difference between the pressure P1 and the pressure P2 is not greater than a maximum difference between the pressure P1 and the pressure P2 set in advance as a set value P0.

Here, if the humidification amount in the fuel cell 25 is appropriate and “YES” is therefore selected in step 110 (i.e., not excessive, which means that the value of the power consumption W is in the region below the broken line (a) in FIG. 4), the program goes to step 112, in which it is determined whether the humidification amount is appropriate. Then, the program goes to step 114 and is temporarily halted. At this time, the fuel cell 25 operates as normal, and the relation between the amount of air supplied by the air blower 37 and the power consumption corresponds to the solid line (b) in FIG. 4 or a region in the vicinity thereof. Then, the program is restarted from step 100, and the processes in steps 102 to 106 are carried out to update the data obtained through detection and calculation.

Then, in step 108, “YES” is selected since the humidification amount was determined to be appropriate in step 112 when the program was executed last time. As long as “YES” is selected in step 110, the humidification amount is determined to be appropriate and the fuel cell 25 operates generally satisfying the relation between the power consumption W and the air amount along the solid line (b) in the map shown in FIG. 4. When “NO” is selected in step 110 after “YES” is selected in step 108, the program goes to step 116, in which it is determined whether the elapsed time period “t” after the selection of “NO” in step 110 is longer than a preset set time period “t1”.

The set time period “t1” is provided to determine whether the determination of “NO” obtained in the process in step 110 is caused by an error, such as through a temporary variation, or is based on reliable detection, and the elapsed time period “t” is a time period measured by the timer provided in the power source system control device 50. If the elapsed time period “t” is longer than the set time period “t1”, it is determined that the determination of “NO” in step 110 is correct and the humidification amount in the fuel cell 25 is excessive. Here, if the elapsed time period “t” is shorter than the set time period “t1” and “NO” is therefore selected, the program goes to step 112, in which it is determined that the humidification amount is appropriate. Then, the program goes to step 114 and is temporarily halted. In this case, the fuel cell 25 continues normal operation.

If the elapsed time period “t” is longer than the set time period “t1” and “YES” is therefore selected in step 116, the program goes to step 118, in which it is determined the humidification amount is excessive. Then, in step 120, a process to raise the temperature of the cooling water for cooling the fuel cell 25 is carried out. The process is carried out by the power source system control device 50, which can change the rotational speed of the motor 27c, can change the operating condition of the water pump 28, or can switch the three-way valve 31 based on the amount by which the temperature should be increased.

That is, to increase the temperature of the fuel cell 25 slightly, the operation of the water pump 28 is slowed down or the rotation of the motor 27c is slowed down or stopped. To increase the temperature of the fuel cell 25 to a large extent, the three-way valve 31 is switched to close the path between the upstream part and the downstream part of the cooling water pipe 29b in order to create a bypassed flow through the upper part of the cooling water pipe 29b, the bypass passage 29c, the downstream part of the cooling water pipe 29a and the fuel cell 25. By selecting and properly carrying out the operations based on the amount by which the temperature should be increased, the temperature of the fuel cell 25 can be increased so that the humidification amount can be decreased by the increased temperature. As a result, the humidification amount in the fuel cell 25 is restored to an appropriate state (the region below the broken line (a) in FIG. 4), and the power generation state of the fuel cell 25 is restored to normal.

When the process to increase the temperature of the fuel cell 25 is completed in step 120, the program goes to step 114 and is temporarily halted. Then, the program is restarted from step 100, and goes to step 108 after the processes in steps 102 to 106. Here, “NO” is selected since the humidification amount was determined to be excessive in step 118 when the program was executed last time and the program goes to step 122. Then, in step 122, it is determined whether or not the power consumption W is greater than the threshold value.

Here, if the value of the power consumption W is in the region above the broken line (a) in FIG. 4 and “YES” is therefore selected in step 122, the program goes to step 124, in which it is determined that the humidification amount is excessive. Then, the program goes to step 120, in which the process to increase the temperature of cooling water for cooling the fuel cell 25 in step 120 described before is carried out. Then, the program goes to step 114 and is temporarily halted.

Then, the program is restarted from step 100, and, as long as “YES” is selected in step 122 after “NO” is selected in step 108, the humidification amount is determined to be excessive in step 124 and a process to increase the temperature of the cooling water for cooling the fuel cell 25 is carried out in step 120 while updating the data obtained through the processes in steps 102 to 106. Also, if the power consumption W is smaller than the threshold value and “NO” is selected in step 122, the program goes to step 126, in which it is determined whether or not the elapsed time period “t” after the selection of “NO” in step 122 is longer than a preset set time period “t2”.

The set time period “t2” is, as in the case with the set time period “t1” described before, prepared to determine whether the determination of “NO” obtained in the process in step 122 is caused by an error such as variation or based on reliable detection, and it is determined that the determination of “NO” in step 122 is correct and the humidification amount in the fuel cell 25 is appropriate if the elapsed time period “t” is longer than the set time period “t2”. Here, if the elapsed time period “t” is shorter than the set time period “t2” and “NO” is therefore selected, the program goes to step 124, in which it is determined that the humidification amount is excessive. Then, the program goes to step 120, and a process to increase the temperature of the cooling water for cooling the fuel cell 25 is carried out. Then, the program goes to step 114 and is temporarily halted.

If the elapsed time period “t” is longer than the set time period “t2” in the process in step 126 and “YES” is therefore selected in step 126, the program goes to step 128, in which it is determined that the humidification amount is appropriate. Then, the fuel cell 25 operates normally, the program goes to step 114 and is temporarily halted. After that, the processes described before are repeated every prescribed time period. When the humidification amount in the fuel cell 25 becomes excessive, the temperature of the cooling water is increased to eliminate the excess humidity in the fuel cell 25 in order to maintain the fuel cell 25 in good operating condition and keep the motorcycle 10 running in a good condition.

As described above, in the fuel cell system according to this embodiment, the determination on the humidification state in the fuel cell 25 is made based on the difference between the electric power consumed to drive the air blower 37 and a threshold value of the power consumption. Therefore, there is no need to change the operating condition of the fuel cell 25 and the control method can thus be simplified. Also, since the determination on the humidification state can be made using the devices which the fuel cell system S originally has, the constitution of the fuel cell system S can be simplified. That is, unlike conventional systems like the one disclosed in JP 2000-243418, there is no need to additionally provide a resistance detector for detecting the internal resistance of the fuel cell, a pressure sensor for detecting the pressure of air supplied from the air supply device to the fuel cell and so on. Also, since the number of devices can be decreases, the fuel cell system S can be smaller in size and the degree of freedom in the layout of the fuel cell 25 can be increased. In addition, since there is no need for members, such as joints, which are needed when additional devices are introduced, the reliability of the pipes and so on is improved.

Also, since the threshold value of the power consumption is set based on the power which the air blower 37 consumes when a constant amount of air is supplied to the fuel cell 25, in which the humidification state changes, and used as map data, the humidification state in the fuel cell 25 can be determined by a simple control using the map. In addition, since the pressure of air being supplied from the air blower 37 to the fuel cell 25 through the gas pipe 38b is set to a value slightly greater than the pressure of air to be discharged from the air discharge port 25a, the pressure of air to be discharged from the air blower 37 can be lowered and the size of the air blower 37 can be decreased.

Also, since a change in the differential pressure between the pressure P1 of air being supplied to the fuel cell 25 and the pressure P2 of waste gas to be discharged from the air discharge port 25a causes a significant change in the power consumption of the motor of the air blower 37, the determination of the humidification state can be easily made and the reliability of the determination can be improved. In addition, since the temperature of the fuel cell 25 is increased by adjusting the cooling capacity of the radiator 27 or switching the three-way valve 31 to form a short flow passage when the inside of the fuel cell 25 is excessively humidified, there is no need to provide new devices and the fuel cell system S can be simplified in structure and reduced in size. Also, wasteful consumption of electric power by an auxiliary device provided in the fuel cell system S can be prevented. Further, when the inside of the fuel cell 25 is excessively humidified, since the air blower 37 is so controlled that as the difference between the power being consumed and the threshold value of the power consumption is greater, the temperature of the cooling water is increased more, the excessive humidification can be resolved properly depending on the humidification amount.

The fuel cell system according to the present invention is not limited to the embodiment described above and may be modified as needed. For example, although the fuel cell system S is applied to the motorcycle 10 in the embodiment described above, the device which uses the fuel cell system is not limited to the motorcycle 10 and may be a vehicle such as a three-wheeled motor vehicle or four-wheeled motor vehicle or a device which uses electric power other than vehicles. Also, although the temperature of the fuel cell 25 can be increased by adjusting the cooling capacity of the radiator 27 or switching the three-way valve 31 to form a short flow passage in the embodiment described above, the fuel cell 25 may instead be heated by a heating device such as a heater. Also, in other embodiments, the excessively humidified state can be resolved in other suitable manners, such as decreasing the humidification amount to hydrogen gas or air and increasing the amount of hydrogen gas or air to be supplied to the fuel cell 25.

In this case, the temperature of the fuel cell 25 can be increased in a short period of time. In addition, increasing the temperature of the fuel cell 25 by adjusting the cooling capacity of the radiator 27 or switching the three-way valve 31 can be combined with decreasing or stopping the driving speed of the water pump 28 and/or the motor 27c, and switching of the three-way valve 31 can be combined before or after these processes. The other parts constituting the fuel cell system according to the present inventions may be modified as needed within the technical scope of the present inventions.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A fuel cell system, comprising:
a fuel cell configured to generate electric power through a reaction between hydrogen gas and oxygen gas in air supplied from an air supply device operated at least in part by an electric motor; and
a humidification state determination controller configured to determine a humidification state of the fuel cell based at least in part on a difference between an amount of electric power consumed by the electric motor when air is supplied from the air supply device to the fuel cell and a threshold value of power consumption.

2. The fuel cell system of claim 1, wherein the threshold value is a preset value stored in a storage device in communication with the humidification state determination controller.

3. The fuel cell system of claim 1, wherein the threshold value of power consumption is set based at least in part on the amount of electric power consumed by the electric motor when a constant amount of air is supplied to the fuel cell.

4. The fuel cell system of claim 1, wherein the pressure of air to be supplied to the fuel cell from the air supply device is set to a pressure greater than the pressure of air discharged from the fuel cell.

5. The fuel cell system of claim 4, further comprising a cooling water device for cooling the fuel cell, wherein the operation temperature controller comprises a cooling water temperature adjuster configured to adjust the cooling capacity of the cooling water device to increase the operating temperature of the fuel cell.

6. The fuel cell system of claim 5, wherein, when the humidification state determination controller determines that the humidity inside the fuel cell is excessive, the cooling water temperature adjuster increases the temperature of cooling water in the cooling water device as the difference between the electric power consumed by the electric motor and the threshold value of power consumption increases.

7. The fuel cell system of claim 1, further comprising an operation temperature controller configured to increase the operating temperature of the fuel cell when the humidification state determination controller determines that the level of humidity in the fuel cell is excessive.

8. A fuel cell system, comprising:
a fuel cell configured to generate electric power through a reaction between hydrogen gas and oxygen gas;
an air supply device in communication with the fuel cell, the air supply device configured to supply air to the fuel cell, the air supply device operated at least in part by an electric motor; and
a controller configured to determine a humidification state of the fuel cell based at least in part on a difference between an amount of electric power consumed by the electric motor to supply air from the air supply device to the fuel cell and a threshold value of power consumption, the controller further configured to adjust the operating temperature of the fuel cell to adjust the humidification state of the fuel cell.

9. The fuel cell system of claim 8, wherein the threshold value is a preset value stored in a storage device in communication with the humidification state determination controller.

10. The fuel cell system of claim 8 further comprising a cooling device configured to provide a cooling medium to the fuel cell, wherein the controller adjusts the cooling capacity of the cooling device to increase the operating temperature of the fuel cell.

11. A method for operating a fuel cell system, comprising:
flowing an amount of air and hydrogen to a fuel cell to generate electricity via a reaction of hydrogen and oxygen in the air;
calculating an amount of power consumed by an air supply device that supplies air to the fuel cell;
comparing the calculated power amount to a threshold power consumption value;
determining based on said comparison if the humidity level in the fuel cell is adequate or excessive; and
adjusting an operating characteristic of the fuel cell system based upon the determination.

12. The method of claim 11, wherein comparing includes using a map of power consumption versus air supplied to the fuel cell to compare the calculated power amount to the threshold power consumption value.

13. The method of claim 11, wherein adjusting the operating characteristic comprises increasing the temperature of cooling water for cooling the fuel cell when the humidity level is determined to be excessive to thereby increase the operating temperature of the fuel cell.

14. The method of claim 11, wherein calculating the amount of power consumed by the air supply device comprises sensing a voltage amount applied to the air supply device, sensing a current amount supplied to the air supply device, and multiplying the sensed voltage and the sensed current.
